(19) United States
(12) Patent Application Publication
(10) Pub. No.: US 2010/0020023 A1
(43) Pub. Date: Jan. 28, 2010

(54) METHOD FOR CONTROLLING MOTION OF PHOTO ON DIGITAL PHOTO FRAME

(75) Inventor: Qing-Hua Liu, Shenzhen City (CN)

Correspondence Address: PCE INDUSTRY, INC.;ATT. Steven Reiss, 288 SOUTH MAYO AVENUE, CITY OF INDUSTRY, CA, 91789, US

(73) Assignees: HONG FU JIN PRECISION INDUSTRY (ShenZhen) CO., LTD., Shenzhen City (CN); HON HAI PRECISION INDUSTRY CO., LTD., Tu-Cheng (TW)

(21) Appl. No.: 12/208,081

(22) Filed: Sep. 10, 2008

(30) Foreign Application Priority Data
Jul. 23, 2008 (CN) 200810302961.2

(51) Int. Cl. G06F 3/041

(52) U.S. Cl. 345/173

(57) ABSTRACT

A method for controlling a motion of a photo on a digital photo frame is disclosed. The method includes establishing a coordinate system on a touch-sensitive screen, sliding over the touch-sensitive screen to make a track, acquiring a start point coordinate (a1, b1), an end point coordinate (a2, b2) and a plurality of sampling points coordinates (Xi, Yi) (i=1, 2 . . . n, n≧2) of the track, getting an equation aX+bY+c=0 according to the start and end points coordinates, and the photo being transformed according to arithmetic.

### BACKGROUND

1. Technical Field

The present invention relates to a method for controlling motion of a photo on a digital photo frame.

2. Description of Related Art

A typical digital photo frame is capable of storing many different types of files such as photos and songs. Digital photo frames may also have more and more motion functions, such as moving a photo to the left or right on the frame screen. Creating this motion of the photo can be complicated.

Therefore, there is room for improvement within the art.

### BRIEF DESCRIPTION OF THE DRAWINGS

FIG. 1 is a block diagram of an embodiment of a method for controlling a motion of a photo on a digital photo frame;

FIG. 2 is a block diagram of another embodiment of a method for controlling a motion of a photo on a digital photo frame;

FIG. 3 is a track view of the method in FIG. 1; and

FIG. 4 is a coordinate view of the method in FIG. 3.

### DETAILED DESCRIPTION OF EMBODIMENTS

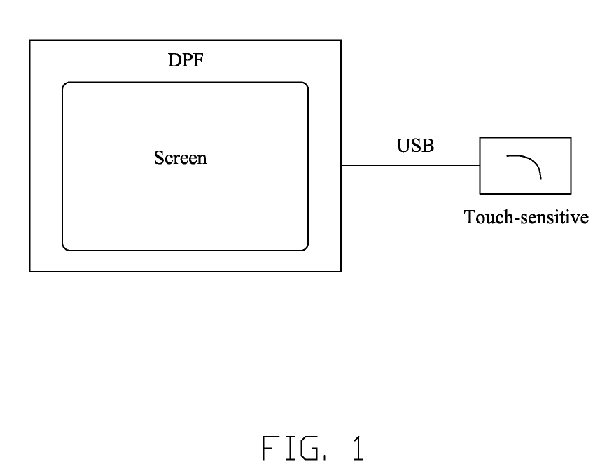

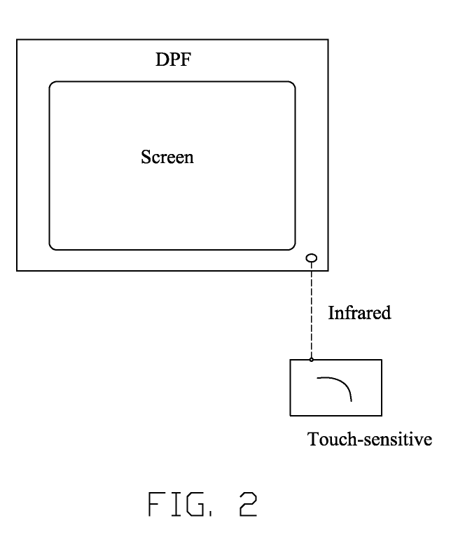

FIGS. 1 and 2 show one embodiment of a method for controlling a motion of a photo on a digital photo frame (DPF) that uses a touch-sensitive telecontrol via a universal serial bus (USB) port to transfer information. Another embodiment uses a touch-sensitive telecontrol via an infrared to transfer information. Another embodiment uses a touch-sensitive display on the DPF.

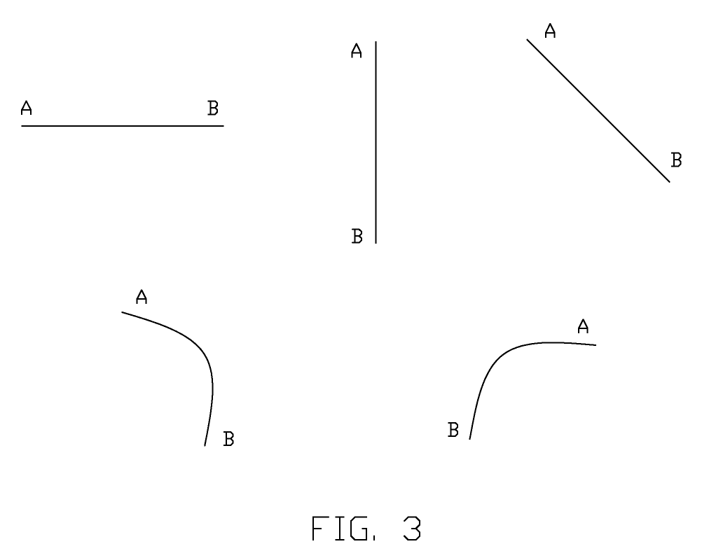

FIG. 3 illustrates exemplary tracks that may be traced on the touch-sensitive screen by a finger or other device. These tracks represent different paths along which a displayed photo may be moved or rotated.

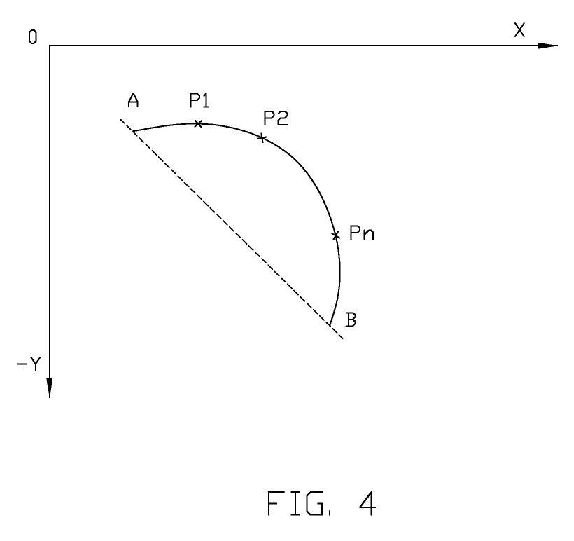

FIG. 4 illustrates the geometry of analyzing the tracks and controlling motion of a photo on the DPF. The origin of coordinates is defined on the left, top corner of the screen to establish a two-dimension coordinate system. Start point coordinates A (a1, b1) and end point coordinates B (a2, b2) of the track AB are acquired. Additionally, a plurality of intermediate sampling points coordinates Pi (Xi, Yi) (i=1, 2 . . . n, n≧2) along parts of the tracing can also be acquired intermediate the start point A and the end point B.

The direct beeline (broken line) between points A and B is defined by an equation aX+bY+c=0. Upon a point along the traced path meeting any of the following conditions, the photo will make an associated motion at that point along the traced path.
(1) when a1=a2,
   if along part of the tracing Xi>a1 and along another part of the tracing Xi<a1,
      or Xi=a1,
      the photo is vertically moved from the start point to the end point;
when b1=b2,
   if along part of the tracing Yi>b1 and along another part of the tracing Yi<b1,
      or Yi=b1,
      the photo is horizontally moved from the start point to the end point;
when a1≠a2, b1≠b2, Xi replaces X in the equation aX+bY+c=0, so Y=−a/bXi−c/b as Yi′ to compare with Yi,
   if Yi′=Yi,
      or along part of the tracing Yi′>Yi and along another part of the tracing Yi′<Yi,
      the photo is obliquely moved from the start point to the end point.

(2) when a1≠a2, b1≠b2, Xi replaces X in the equation aX+bY+c=0, so Y=−a/bXi−c/b as Yi′ to compare with Yi,
if Yi′>Yi and a1<a2, the photo is rotated counterclockwise;
if Yi′>Yi and a1>a2, the photo is rotated clockwise;
if Yi′<Yi and a1<a2, the photo is rotated clockwise;
if Yi′<Yi and a1>a2, the photo is rotated counterclockwise.

(3) when a1=a2,
if Xi>a1 and b1<b2, the photo is rotated counterclockwise;
if Xi>a1 and b1>b2, the photo is rotated clockwise;
if Xi<a1 and b1<b2, the photo is rotated clockwise;
if Xi<a1 and b1>b2, the photo is rotated counterclockwise.

(4) when b1=b2,
if Yi>b1 and a1<a2, the photo is rotated clockwise;
if Yi>b1 and a1>a2, the photo is rotated counterclockwise;
if Yi<b1 and a1<a2, the photo is rotated counterclockwise;
if Yi<b1 and a1>a2, the photo is rotated clockwise.

It is to be understood, however, that even though numerous characteristics and advantages of the present embodiments have been set forth in the foregoing description, together with details of the structure and function of the embodiments, the disclosure is illustrative only, and changes may be made in detail, especially in matters of shape, size, and arrangement of parts within the principles of the embodiments to the full extent indicated by the broad general meaning of the terms in which the appended claims are expressed.

What is claimed is:

1. A method for controlling motion of a photo on a digital photo frame (DPF) comprising:
establishing a coordinate system on a touch-sensitive screen;
tracing a track over the touch-sensitive screen;
analyzing the track by acquiring a start point coordinate (a1, b1), an end point coordinate (a2, b2) and a plurality of intermediate sampling points coordinates (Xi, Yi) (i=1, 2 . . . n, n≧2) of the track;
using the equation aX+bY+c=0 which defines a direct beeline between the start point and the end point to determine the motion of the photo, such that
when a1=a2,
if along part of the tracing Xi>a1 and along another part of the tracing Xi<a1,
or Xi=a1,
the photo is vertically moved from the start point to the end point;
when b1=b2,
if along part of the tracing Yi>b1 and along another part of the tracing Yi<b1,
or Yi=b1,
the photo is horizontally moved from the start point to the end point;
when a1≠a2, b1≠b2, Xi replaces X in the equation aX+bY+c=0, so Y=−a/bXi−c/b as Yi′ to compare with Yi,
if Yi′=Yi,
or along part of the tracing Yi′>Yi and along another part of the tracing Yi′<Yi,
the photo is obliquely moved from the start point to the end point.

2. The method of claim 1, wherein when a1≠a2, b1≠b2, Xi replaces X in the equation aX+bY+c=0, so Y=−a/bXi−c/b as Yi′ to compare with Yi,
if Yi′>Yi and a1<a2, the photo is rotated counterclockwise;
if Yi′>Yi and a1>a2, the photo is rotated clockwise;
if Yi′<Yi and a1<a2, the photo is rotated clockwise;
if Yi′<Yi and a1>a2, the photo is rotated counterclockwise.

3. The method of claim 1, wherein when a1=a2,
if Xi>a1 and b1<b2, the photo is rotated counterclockwise;
if Xi>a1 and b1>b2, the photo is rotated clockwise;
if Xi<a1 and b1<b2, the photo is rotated clockwise;
if Xi<a1 and b1>b2, the photo is rotated counterclockwise.

4. The method of claim 1, wherein when b1=b2,
if Yi>b1 and a1<a2, the photo is rotated clockwise;
if Yi>b1 and a1>a2, the photo is rotated counterclockwise;
if Yi<b1 and a1<a2, the photo is rotated counterclockwise;
if Yi<b1 and a1>a2, the photo is rotated clockwise.

5. The method of claim 1, wherein the DPF has a touch-sensitive telecontrol.
